(19) United States
(12) Patent Application Publication
(10) Pub. No.: US 2026/0334362 A1
(43) Pub. Date: Oct. 29, 2026

(54) SUGARCANE HARVESTER ADJUSTMENT SYSTEM AND METHOD

(71) Applicant: Deere & Company, Moline, IL (US)

(72) Inventors: Dilip Dhapse, Pune (IN); Sourin Ghosh, Pune (IN); Veer Bhansari, Pune (IN); Abhishek Agarwal, Pune (IN); Nikhil P. Shevkar, Pune (IN); Gaurav Kothyari, Pune (IN); Kedarnath Rugge, Pune (IN); Shibinkumar Krishnakumar, Pune (IN)

(21) Appl. No.: 19/186,958

(22) Filed: Apr. 23, 2025

(51) Int. Cl. A01D 45/10; A01D 43/08

(52) U.S. Cl. CPC A01D 45/10; A01D 43/085

(57) ABSTRACT

An agricultural machine configured to process sugarcane in a worksite includes a chopper, a chute, a sensor, and a controller. The chopper is configured to cut stalks of the sugarcane into billets. The chute is configured to receive crop residue from the chopper and output material including the crop residue from the agricultural machine. The sensor is configured to capture one or more images of the material output by the chute. The controller is configured to receive one or more signals from the sensor indicative of the one or more images and adjust at least one crop processing parameter of the agricultural machine based on the one or more signals.

### FIELD OF THE DISCLOSURE

The present disclosure relates to a sugarcane harvester and more particularly to systems and methods for adjusting actuators of the harvester that affect collection of sugarcane billets.

### BACKGROUND

A sugarcane harvester severs sugarcane plants from the ground with a base cutter assembly and transports the severed plants to a set of chopping drums that cut the severed plant into smaller billets. The billets are directed through a cleaning system to separate the billets from crop residue such as leaves, dirt, and other non-billet material. The billets are then discharged, for example, into a collection vehicle.

### SUMMARY

In an implementation of the present disclosure, an agricultural machine configured to process sugarcane in a worksite comprises: a chopper configured to cut stalks of the sugarcane into billets; at least one chute configured to receive crop residue from the chopper and output material including the crop residue from the agricultural machine; at least one sensor configured to capture one or more images of the material output by the at least one chute; and a controller configured to receive one or more signals from the at least one sensor indicative of the one or more images and adjust at least one crop processing parameter of the agricultural machine based on the one or more signals.

In some implementations, the controller is configured to identify billets in the one or more images based on at least one parameter associated with the material output by the at least one chute. In some implementations, the controller is configured to: compare a quantity of billets identified in the one or more images to a target quantity of billets; and adjust the at least one crop processing parameter of the agricultural machine if the quantity of billets identified in the one or more images is beyond an accepted difference from the target quantity of billets.

In some implementations, the at least one parameter associated with the material output by the at least one chute is size of the material output by the at least one chute. In some implementations, the at least one parameter associated with the material output by the at least one chute is shape of the material output by the at least one chute. In some implementations, the at least one parameter associated with the material output by the at least one chute is trajectory of the material output by the at least one chute. . In some implementations, the at least one parameter associated with the material output by the at least one chute is speed of the material output by the at least one chute. In some implementations, the at least one parameter associated with the material output by the at least one chute is color of the material output by the at least one chute. In some implementations, the controller is configured to associate identified billets with locations in the worksite.

In some implementations, the at least one sensor is at least one camera having one or more fields of view sufficient to capture images of the material output by the at least one chute. In some implementations, the at least one chute includes: a first chute configured to output material including crop residue from the agricultural machine; and a second chute that is configured to: (i) receive crop residue that is not output from the agricultural machine by the first chute and (ii) output additional material, including crop residue that is not output from the agricultural machine by the first chute, from the agricultural machine. In some implementations, the at least one sensor is at least one camera having one or more fields of view sufficient to capture images of the material output by the first chute and the additional material output by the second chute.

In some implementations, the at least one chute includes a first chute and a second chute that is configured to receive crop residue that is not output from the agricultural machine by the first chute; and the at least one crop processing parameter of the agricultural machine that the controller is configured to adjust includes: (i) speed of a first fan that is configured to produce airflow that moves the material through the first chute and (ii) speed of a second fan that is configured to produce airflow that moves the material through the second chute.

In some implementations, the at least one crop processing parameter of the agricultural machine that the controller is configured to adjust includes speed of at least one fan configured to produce airflow that moves the material through the at least one chute.

In some implementations, the agricultural machine further comprises at least one knockdown roller configured to convey the sugarcane towards the chopper. In some implementations, the at least one crop processing parameter of the agricultural machine that the controller is configured to adjust includes speed of the at least one knockdown roller. In some implementations, the at least one crop processing parameter of the agricultural machine that the controller is configured to adjust includes speed of the agricultural machine moving through the worksite.

In another illustrative implementation, an agricultural machine configured to process sugarcane in a worksite comprises: at least one knockdown roller configured to convey the sugarcane towards a chopper that is configured to cut stalks of the sugarcane into billets; at least one chute that is positioned downstream of the chopper, configured receive material obtained from the worksite including crop residue, and configured to output the material from the agricultural machine; at least one sensor configured to measure a parameter associated with the material output by the at least one chute; and a controller configured to receive one or more signals from the at least one sensor indicative the parameter measured by the at least one sensor and adjust at least one crop processing parameter of the agricultural machine based on the one or more signals.

In some implementations, the at least one crop processing parameter of the agricultural machine that the controller is configured to adjust includes speed of the agricultural machine moving through the worksite. In some implementations, the at least one crop processing parameter of the agricultural machine that the controller is configured to adjust includes speed of the at least one knockdown roller. In some implementations, the at least one crop processing parameter of the agricultural machine that the controller is configured to adjust includes speed of at least one separator configured to separate billet from crop residue in the at least one chute.

In another illustrative implementation, a method of processing sugarcane with an agricultural machine in a worksite comprises: moving the agricultural machine at a harvesting speed through the worksite; rotating a knockdown roller of the agricultural machine at a knockdown roller speed to convey the sugarcane through the agricultural machine; chopping stalks of the sugarcane into billets; rotating a fan at a fan speed to generate airflow that separates billets from crop residue; measuring a parameter associated with material, including billets and crop residue, output from the agricultural machine; and adjusting at least one crop processing parameter of the agricultural machine based on the measured parameter associated with the material, wherein the at least one crop processing parameter includes at least one of the harvesting speed, the knockdown roller speed, and the fan speed.

### BRIEF DESCRIPTION OF THE DRAWINGS

FIG. 1A is a perspective view of an agricultural machine;

FIG. 1B is a side view of the agricultural machine of FIG. 1A;

FIG. 1C is a cross-sectional side view of a portion of the agricultural machine of FIGS. 1A and 1B;

FIG. 2 is a diagrammatic view of a control system usable to adjust one or more crop processing parameters of the agricultural machine; and

FIG. 3 is a flow diagram showing an example method of processing sugarcane with the agricultural machine in a worksite.

### DETAILED DESCRIPTION

It should be understood that the disclosure is not limited in its application to the details of construction and the arrangement of components set forth in the following description or illustrated in the accompanying drawings. The disclosure is capable of supporting other implementations and of being practiced or of being carried out in various ways. Also, it should be understood that the phraseology and terminology used herein is for the purpose of description and should not be regarded as limiting.

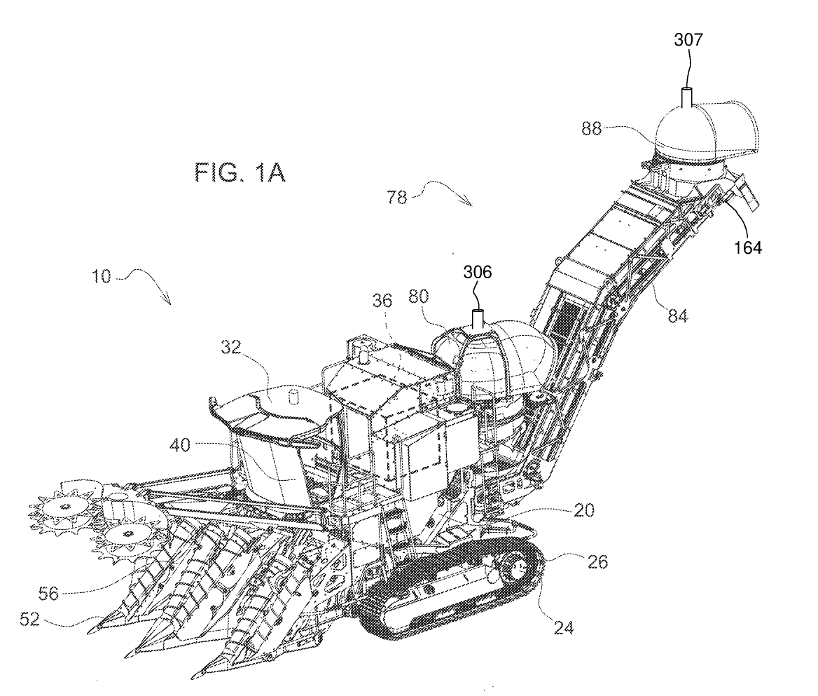

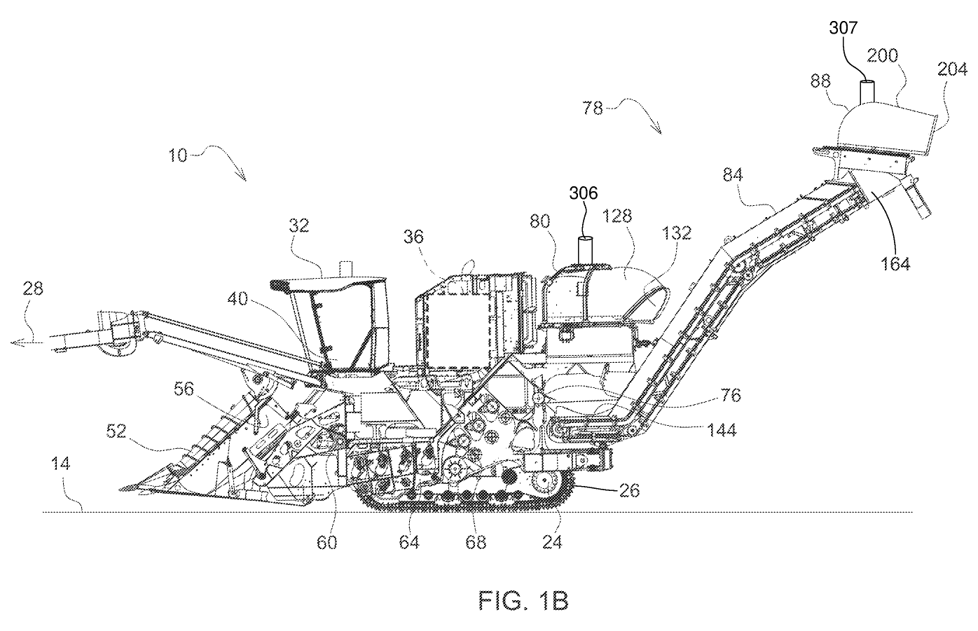

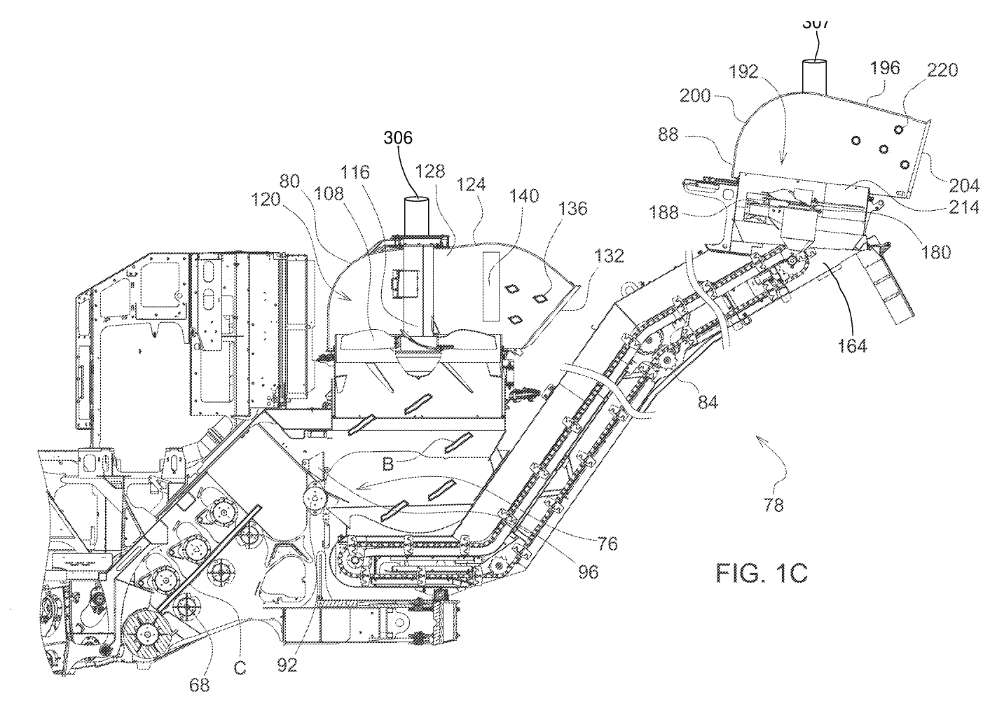

FIG. 1A illustrates an agricultural machine 10, such as a sugarcane harvester, configured to harvest crop from a worksite 14. The illustrated agricultural machine 10 includes a main frame 20 supported on one or more ground-engaging mechanisms 24 such as wheels or tracks that engage the ground of the worksite 14 in order to move the agricultural machine 10 across the ground 14 in a direction of travel 28 (see FIG. 1B). In some implementations, the ground-engaging mechanisms 24 may include continuous tracks 26 or other traction devices. An operator’s cab 32 is mounted on the frame 20, for example, above a prime mover 36, such as an engine. The prime mover 36 may be an internal combustion engine or other such device for providing motive power. The agricultural machine 10 includes a user interface 320, which may include a throttle control 40 (e.g., a lever, button, switch, pedal, touch screen display) for controlling a speed of the prime mover 36 and thus a speed of the agricultural machine 10 (also referred to as the harvesting speed). The agricultural machine 10 includes one or more crop lifters 52 mounted to the front of the frame 20, defining one or more inlets 56 for receiving the crop being harvested from the worksite 14.

FIG. 1B illustrates a side view of the agricultural machine 10 with some portions thereof removed. The crop lifters 52 cooperate with one or more knockdown rollers 60 and one or more base cutters 64 to process the crop obtained from the worksite 14 during a harvesting operation. The feed rollers 68 are disposed downstream of the one or more knockdown rollers 60 and the base cutter 64 and receive the crop therefrom. The one or more knockdown rollers 60 operate at a knockdown roller speed, which is adjustable by one or more knockdown roller actuators 67 coupled to the one or more knockdown rollers 60. Each feed roller 68 operates at a feed roller speed, which is adjustable by one or more feed roller actuators 69 coupled to the feed rollers 68. The agricultural machine 10 further includes a chopper 76 and a cleaning system 78. In some implementations, the cleaning system 78 includes a first chute 80. In some implementations, the cleaning system 78 includes the first chute 80 and a second chute 88. In such implementations, the agricultural machine 10 also includes an elevator 84 connecting the first chute 80 and the second chute 88.

FIG. 1C illustrates the chopper 76 and the cleaning system 78 in more detail. The chopper 76 is disposed adjacent to and downstream of the feed rollers 68 and is configured to cut the crop. The chopper 76 may include a set of chopper drums 92 driven by a motor. The chopper drums 92 include a blade 96 for cutting the stalks of the crop. In some implementations, the chopper 76 includes a counter rotating drum cutters having overlapping blades. In other implementations, the chopper 76 may include any suitable blade or blades for cutting the stalks of crop. The chopper 76 cuts stalks of crop, referred to as cane, into crop billets B, which include pieces of the stalks. The crop also includes dirt, leaves, roots, and other plant matter, which is collectively referred to herein as crop residue (e.g., crop residue 136). The chopper 76 operates at a chopper speed, which may be adjusted by one or more chopper actuators 71 to change a size and weight of the resulting cut crop. The chopper 76 directs a stream of the cut crop, also referred to herein as “material” (including crop billets B and crop residue 136), to the cleaning system 78 and specifically to the first chute 80.

The first chute 80 is coupled to the frame 20 and disposed downstream of the chopper 76 for receiving cut crop from the chopper 76. The first chute 80 generally separates the crop residue 136 from the billets B by way of a first cleaning mechanism, such as a fan, a source of compressed air, a rake, a shaker, or any other separator that distinguishes various types of crop parts by weight, size, shape, etc. in order to separate crop residue 136 from billets B. In the illustrated implementation, the first chute 80 includes a first fan 108 driven at a first fan speed by a first fan actuator 116, such as a motor. Thus, in the illustrated implementation, a first cleaning speed may include the first fan speed; however in other implementations, the first cleaning speed may include air speed (e.g., of released compressed air or any other pressurized air), rake speed, shaker speed, etc. The first chute 80 further includes a primary cleaning chamber 120 generally defined by a primary cleaner housing 124.

Referring still to FIG. 1C, the first chute 80 includes a primary hood 128 coupled to the main frame 20. The primary hood 128 may have a domed shape, or other suitable shape for directing material out from the agricultural machine 10, and includes a primary opening 132 (also referred to herein as first outlet 132). In the illustrative implementation, the first outlet 132 is angled to direct material away from the agricultural machine 10 and faces slightly downward towards the ground of the worksite 14. The hood directs crop residue 136 through the first outlet 132, outside of the agricultural machine 10, and onto the ground of the worksite 14. In some implementations the first chute 80 includes a primary shredder 140 that shreds the crop residue 136 into smaller pieces. A portion of the processed crop, including mostly billets B, is directed to another outlet of the primary cleaning chamber 120 and is deposited in a basket 144 disposed below the first chute 80.

With continued reference to FIG. 1C, the elevator 84 is coupled to a rear end of the frame 20 for receiving the processed crop from the basket 144. The elevator 84 extends from the rear of the agricultural machine 10 and terminates at a discharge opening 164, which, in some implementations, is elevated to a height suitable for discharging billets into a collection vehicle. Unlikely the first outlet 132, the discharge opening 164 is configured to discharge the processed crop into a collection vehicle, which is configured to collect billets of sugarcane.

In some implementations, the second chute 88 is disposed above and adjacent to the discharge opening 164 and configured discharge additional material including additional crop residue 220 out from the agricultural machine 10 and onto the ground of the worksite 14. The second chute 88 generally separates the crop residue 220 from the billets B by way of a second cleaning mechanism such as a fan, a compressed air source, a rake, a shaker, or any other separator that distinguishes various types of crop parts by weight, size, shape, etc. in order to separate crop residue 220 from billets B. In the illustrated implementation, the second chute 88 includes a second fan 180 driven at a second fan speed by a second fan actuator 188, such as a motor. The second chute 88 includes a secondary cleaning chamber 192 defined by a secondary cleaner housing 196. Thus, in the illustrated implementation, a second cleaning speed may include the second fan speed; however in other implementations, the second cleaning speed may include air speed (e.g., of released compressed air or any other pressurized air), rake speed, shaker speed, etc. It should be appreciated that as referred to herein “crop processing parameters” of the agricultural machine 10 include the knockdown roller speed, the feed roller speed, the chopper speed, the first cleaning speed (e.g., the first fan speed), and the second cleaning speed (e.g., the second fan speed).

Referring still to FIG. 1C, the secondary cleaner housing 196 includes a secondary hood 200 having a second outlet 204. The second chute 88 is configured to discharge additional material, including additional crop residue 220, through the second outlet 204 out of the agricultural machine 10 and onto the ground of the worksite 14. In some implementations, the second chute 88 includes a secondary shredder 214 that shreds the additional crop residue 220 into smaller pieces before being discharged.

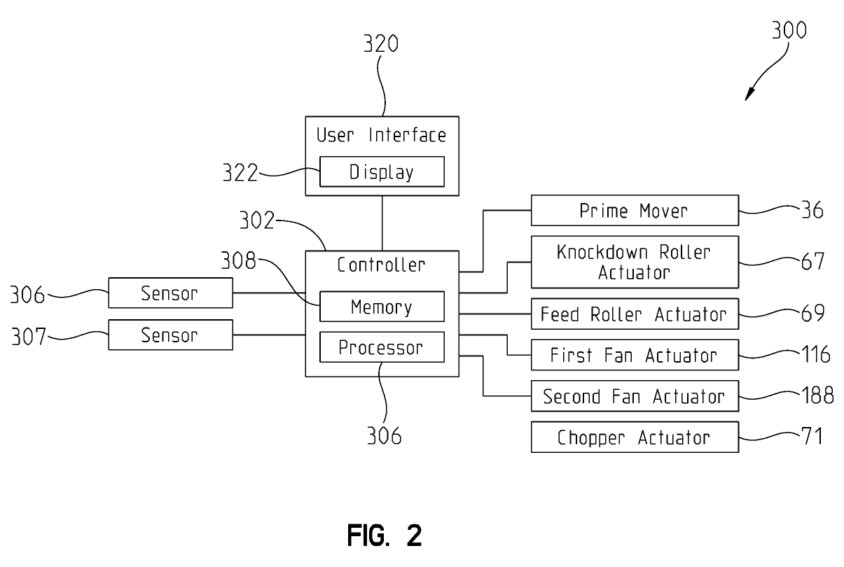

Referring now to FIG. 2, an example control system 300 is shown. The control system 300 includes one or more memories 308 included in or accessible by the controller 302 and one or more processors 306 included in or accessible by the controller 302. The one or more processors 306 are configured to execute instructions (e.g., one or more algorithms) stored on the one or more memories 308. The controller 302 may be a single controller or a plurality of controllers operatively coupled to one another. The controller 302 may be positioned on the agricultural machine 10 or positioned remotely, away from the agricultural machine 10. The controller 302 may be coupled via a wired connection or wirelessly to other components of the agricultural machine 10 and to one or more remote devices. In some instances, the controller 302 may be connected wirelessly via Wi-Fi, Bluetooth, Near Field Communication, or another wireless communication protocol to other components of the agricultural machine 10 and to one or more remote devices.

Referring still to FIG. 2, in the illustrative implementation, the controller 302 is operatively coupled to at least one sensor, e.g., sensor 306, sensor 307, or both. The sensors 306, 307 are also shown in FIGS. 1A, 1B, 1C. In some implementations, the sensor 306 is positioned on an exterior portion of the first chute 80. For example, the sensor 306 may be positioned on the primary hood 128. In some implementations, the sensor 307 may be positioned on an exterior portion of the second chute 88 or on an exterior portion of the elevator 84. In some implementations, one or both of the sensors 306, 307 are cameras. In some implementations, the sensor 306 may have a field of view sufficient to capture one or more images of the material output by the first chute 80. In some implementations, the sensor 306 may have a field of view sufficient to capture one or more images of the material output by the first chute 80 and the additional material output by the second chute 88. In some implementations, the sensor 306 may have a field of view sufficient to capture one or more images of the material output by the first chute 80, and the sensor 307 may have a field of view sufficient to capture one or more images of the material output by the second chute 88. In the illustrative implementation, the controller 302 is configured to receive data corresponding to the one or more images of the field of view of the at least one sensor.

It should be appreciated that in some implementations, the at least one sensor (e.g., 306, 307) may be embodied as one or more cameras (e.g., optical or visual radiation cameras or red, green, blue (RGB) cameras), LiDAR sensors, radar sensors (e.g., long-range terahertz radar, mm wave radar, ultra-wideband radar, frequency-modulated continuous wave radar (FMCW), ultrasonic sensors, thermal sensors (e.g., a thermal cameras), stereo cameras, laser vibrometers, infrared nuclear magnetic resonance (NMR) cameras, infrared short-wave infrared (SWIR) cameras, infrared terahertz sensors, or another sensor operable to capture or generate one or more images or data corresponding to the one or more images of the field of view of the sensor.

Referring still to FIG. 2, in some implementations, the controller 302 is operatively coupled to a display, for example, the display 322 of the user interface 320, and configured to send one or more signals to the display based on the one or more signals received from the at least one sensor 306, 307. In some implementations, the controller 302 is configured to send one or more signals to the display based a determination (by the controller 302) of the amount of billet shown in one or more images. In the illustrative implementation, the controller 302 is operatively coupled to the user interface 320 and configured to receive one or more signals from the user interface 320, which may include inputs for crop processing parameters of the agricultural machine 10 (e.g., harvesting speed, knockdown roller speed, feed speed, chopper speed, first cleaning speed (e.g., first fan speed), and second cleaning speed (e.g., second fan speed).

In some implementations, the crop processing parameters of the agricultural machine 10 are input by a user via the user interface 320 based on the displayed determination of the amount of billets shown in the one or more images provided by the at least one sensor. It should be appreciated that in some implementations, the controller 302 is configured to adjust one or more of the crop processing parameters of the agricultural machine 10 automatically (e.g., based on a determination of amount of billets shown in one or more images of the field of view and without additional instruction from the user interface 320).

In some implementations, the agricultural machine 10 is included in a fleet of agricultural machines, which may include other agricultural machines (e.g., sugarcane harvesters, aerial vehicles, collection vehicles) that may operate in the same worksite 14 as the agricultural machine 10 or different worksites (at the same or different times). In some implementations, the controller 302 is configured to receive one or more signals indicative of one or more additional images (of discharged material including billets, crop residue, or both) from one or more other sensors on the other agricultural machines that are included in the fleet.

In some implementations, the control system 200 leverages machine learning to more accurately determine the amount of billets shown in the one or more images obtained from the at least one sensor 306, 307 of the agricultural machine 10. For example, in some implementations, the controller 302 is configured to compare the data corresponding to the one or more images received from the at least one sensor 306, 307 to data corresponding to the one or more additional images (from one or more other sensors on the other agricultural machines that are included in the fleet) to determine the amount of billets shown in the one or more images obtained from the at least one sensor 306, 307 of the agricultural machine 10. In some implementations, more broadly, the controller 302 is configured to compare the data corresponding to the one or more images received from the at least one sensor 306, 307 to data corresponding to one or more other images of material (including billets, crop residue, or both) to determine the amount of billets shown in the one or more images obtained from the at least one sensor 306, 307 of the agricultural machine 10.

Referring still to FIG. 2, in some implementations, the controller 302 is operatively coupled to one or more of the at least one knockdown roller actuators 67, the at least one feed roller actuators 69, the at least one chopper actuators 71, at least one first cleaning speed actuators (e.g., the first fan actuator 116), and at least one second cleaning speed actuators (e.g., the second fan actuator 188). Each of the actuators (e.g., actuators 67, 69, 71, 116, 188) may be embodied as at least one of a control valve, a motor, a linear (e.g., cylindrical) actuator, a rotary actuator, or another actuator configured to cause adjustment of a crop processing characteristic of the agricultural machine 10. In some implementations, the controller 302 may send one or more signals to the at least one knockdown roller actuator 67 to adjust the speed of the one or more knock down rollers 60 based on the one or more signals received from the at least one sensor 306, 307. In some implementations, the controller 302 may send one or more signals to the at least one feed roller actuator 69 to adjust the speed of the one or more feed rollers 68 based on the one or more signals received from the at least one sensor 306, 307. In some implementations, the controller 302 may send one or more signals to the at least one chopper actuator 71 to adjust the speed of the chopper 76 based on the one or more signals received from the at least one sensor 306, 307.

In some implementations, the controller 302 is configured to send one or more signals to the first cleaning speed actuator (e.g., the first fan actuator 116) to adjust the first cleaning speed (e.g., speed of the first fan 108) based on the one or more signals received from the at least one sensor 306, 307. In some implementations, the controller 302 is configured to send one or more signals to the second cleaning speed actuator (e.g., the second fan actuator 188) to adjust the second cleaning speed (e.g., speed of the second fan 180) based on the one or more signals received from the at least one sensor 306, 307. As shown in FIG. 2, in some implementations, the controller 302 is operatively coupled to the prime mover 36 of the agricultural machine 10 and configured send one or more signals to the prime mover 36 to adjust the harvesting speed of the agricultural machine 10.

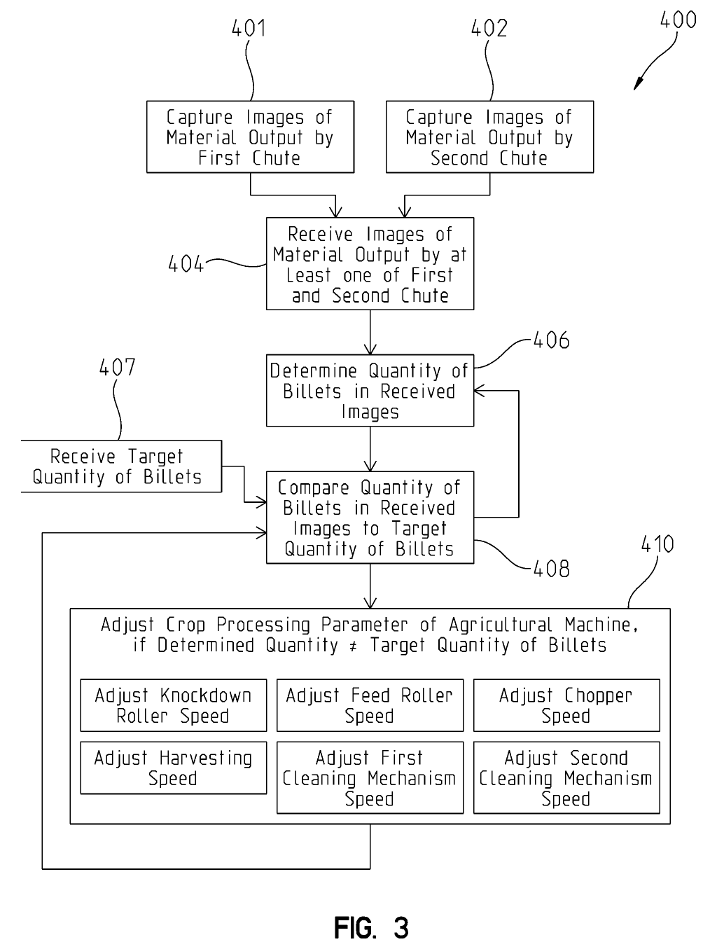

In an example method 400 that is shown in FIG. 3, the controller 302 receives one or more signals from the at least one sensor 306, 307 indicative of the one or more images captured by the at least one sensor 306, 307 and adjusts at least one crop processing parameter of the agricultural machine 10 based on the one or more signals.

At a block 401, the sensor 306 captures one or more images of material output by the first chute 80. In some implementations, the material output by the first chute 80 may include billets and crop residue. In some implementations, at a block 402, the sensor 307 captures one or more images of additional material output by the second chute 88. In some implementations, the additional material output by the second chute 88 may include billets and additional crop residue. At a block 404, the controller 302 receives one or more signals from the at least one sensor 306, 307 indicative of the one or more images captured by the at least one sensor 306, 307. It should be appreciated that in various implementations, the controller 302 receives one or more signals from sensor 306, the sensor 307, or both.

In some implementations, at a block 406, the controller 302 determines the quantity of billets in the one or more images received from at least one sensor 306, 307. For example, the controller 302 may use machine learning to determine the quantity of billets in the one or more images received from the at least one sensor 306, 307. In such implementations, the controller 302 may compare the one or more images received from the at least one sensor 306, 307 to one or more additional or other images or data sets to more accurately determine the quantity of billets in the one or more images received from the at least one sensor 306, 307.

In some implementations, the controller 302 determines the quantity of billets in the one or more images received from the at least one sensor 306, 307 based on at least one parameter associated with the material output by the first chute 80, the second chute 88, or both. In some implementations, the at least one parameter associated with the material output by the first chute 80, the second chute 88, or both is size of the material. In some implementations, the at least one parameter associated with the material output by the first chute 80, the second chute 88, or both is the shape of the material. In some implementations, the at least one parameter associated with the material output by the first chute 80, the second chute 88, or both is the color of the material. In some implementations, the at least one parameter associated with the material output by the first chute 80, the second chute 88, or both is the trajectory of the material. In some implementations, the at least one parameter associated with the material output by the first chute 80, the second chute 88, or both is the speed of the material.

In such implementations, the controller 302 compares one or more of the size, shape, color, trajectory, and speed of the material to data associated with one or more of the known size, shape, color, trajectory, and speed of billets to identify and quantify the billets in the material. It should be appreciated that the term “parameter associated with the material” includes but is not limited to size, shape, color, trajectory, and speed of the material.

In some implementations, the controller 302 associates the identified or quantified billets with a specific location in the worksite 14. For example, the agricultural machine 10 may include a Global Positioning System (GPS) sensor or other device configured to determine the location of the agricultural machine 10 during a harvesting operation of the agricultural machine 10. In some implementations, the controller 302 sends one or more signals to the user interface 320 causing the user interface 320 to display data associated with the identified or quantified billets by location in the worksite 14. In some implementations, the data including the association between the identified or quantified billets and location in the worksite 14 of such billets is stored in the memory 308 of the controller 302. In this manner, the controller 302 is configured to create a harvesting loss map that shows the quantity of billets that are output by the first chute 80, the second chute 88, or both (and therefore not collected by the collection vehicle).

Referring still to FIG. 3, in some implementations, at a block 408, the controller 302 compares the quantity of billets identified in the one or more images received from the at least one sensor 306, 307 to a target quantity of billets to determine whether the quantity of billets identified in the one or more images received from the at least one sensor 306, 307 is beyond an acceptable difference (i.e., outside an acceptable range) from the target quantity of billets. In some implementations, the target quantity of billets (e.g., maximum acceptable billet loss) may be input by a user into the user interface 320 and received by the controller 302 from the user interface 320 (at a block 407). Whether or not received from the user interface 320, the target quantity of billets is stored in the memory 308 of the controller 302.

Referring still to FIG. 3, in some implementations, at a block 410, the controller 302 adjusts at least one crop processing parameter of the agricultural machine 10 if the quantity of billets identified in the one or more images received from the at least one sensor 306, 307 is beyond an acceptable difference (i.e., outside an acceptable range) from the target quantity of billets. For example, in some implementations, at a block 412, the controller 302 sends one or more signals to the at least one knockdown roller actuator 67 to adjust the speed of the one or more knockdown rollers 60. In some implementations, at a block 414, the controller 302 sends one or more signals to the at least one feed roller actuator 69 to adjust the speed of the one or more feed rollers 68. In some implementations, at a block 416, the controller 302 sends one or more signals to the at least one chopper actuator 71 to adjust the speed of the chopper 76. In some implementations, at a block 418, the controller 302 sends one or more signals to the at least one first cleaning speed actuator (e.g., the first fan actuator 116) to adjust the speed of the first cleaning mechanism (e.g., the first fan 108). In some implementations, at a block 420, the controller 302 sends one or more signals to the at least one second cleaning speed actuator (e.g., the second fan actuator 188) to adjust the speed of the second cleaning mechanism (e.g., the second fan 180). In some implementations, at a block 422, the controller 302 sends one or more signals to the prime mover 36 to adjust the speed of the agricultural machine 10 moving through the worksite 14 (i.e., the harvesting speed). It should be appreciated that in the method 400, the controller 302 may adjust one or more of the crop processing parameters of the agricultural machine 10 based on the one or more signals received from at least one sensor 306, 307.

While exemplary implementations incorporating the principles of the present disclosure have been described herein, the present disclosure is not limited to such implementations. Instead, this application is intended to cover any variations, uses, or adaptations of the disclosure using its general principles. Further, this application is intended to cover such departures from the present disclosure as come within known or customary practice in the art to which this disclosure pertains.

1. An agricultural machine configured to process sugarcane in a worksite, comprising:
a chopper configured to cut stalks of the sugarcane into billets;
at least one chute configured to receive crop residue from the chopper and output material including the crop residue from the agricultural machine;
at least one sensor configured to capture one or more images of the material output by the at least one chute; and
a controller configured to receive one or more signals from the at least one sensor indicative of the one or more images and adjust at least one crop processing parameter of the agricultural machine based on the one or more signals.

2. The agricultural machine of claim 1, wherein the controller is configured to identify billets in the one or more images based on at least one parameter associated with the material output by the at least one chute.

3. The agricultural machine of claim 2, wherein the controller is configured to:
compare a quantity of billets identified in the one or more images to a target quantity of billets; and
adjust the at least one crop processing parameter of the agricultural machine if the quantity of billets identified in the one or more images is beyond an accepted difference from the target quantity of billets.

4. The agricultural machine of claim 2, wherein the at least one parameter associated with the material output by the at least one chute is size of the material output by the at least one chute.

5. The agricultural machine of claim 2, wherein the at least one parameter associated with the material output by the at least one chute is shape of the material output by the at least one chute.

6. The agricultural machine of claim 2, wherein the at least one parameter associated with the material output by the at least one chute is trajectory of the material output by the at least one chute.

7. The agricultural machine of claim 2, wherein the at least one parameter associated with the material output by the at least one chute is speed of the material output by the at least one chute.

8. The agricultural machine of claim 2, wherein the at least one parameter associated with the material output by the at least one chute is color of the material output by the at least one chute.

9. The agricultural machine of claim 2, where the controller is configured to associate identified billets with locations in the worksite.

10. The agricultural machine of claim 1, wherein the at least one sensor is at least one camera having one or more fields of view sufficient to capture images of the material output by the at least one chute.

11. The agricultural machine of claim 1, wherein the at least one chute includes:
a first chute configured to output material including crop residue from the agricultural machine; and
a second chute that is configured to: (i) receive crop residue that is not output from the agricultural machine by the first chute and (ii) output additional material, including crop residue that is not output from the agricultural machine by the first chute, from the agricultural machine; and
wherein the at least one sensor is at least one camera having one or more fields of view sufficient to capture images of the material output by the first chute and the additional material output by the second chute.

12. The agricultural machine of claim 11, wherein the at least one chute includes a first chute and a second chute that is configured to receive crop residue that is not output from the agricultural machine by the first chute; and
wherein the at least one crop processing parameter of the agricultural machine that the controller is configured to adjust includes: (i) speed of a first fan that is configured to produce airflow that moves the material through the first chute and (ii) speed of a second fan that is configured to produce airflow that moves the material through the second chute.

13. The agricultural machine of claim 1, wherein the at least one crop processing parameter of the agricultural machine that the controller is configured to adjust includes speed of at least one fan configured to produce airflow that moves the material through the at least one chute.

14. The agricultural machine of claim 1, further comprising at least one knockdown roller configured to convey the sugarcane towards the chopper;
wherein the at least one crop processing parameter of the agricultural machine that the controller is configured to adjust includes speed of the at least one knockdown roller.

15. The agricultural machine of claim 1, wherein the at least one crop processing parameter of the agricultural machine that the controller is configured to adjust includes speed of the agricultural machine moving through the worksite.

16. An agricultural machine configured to process sugarcane in a worksite, comprising:
at least one knockdown roller configured to convey the sugarcane towards a chopper that is configured to cut stalks of the sugarcane into billets;
at least one chute that is positioned downstream of the chopper, configured receive material obtained from the worksite including crop residue, and configured to output the material from the agricultural machine;
at least one sensor configured to measure a parameter associated with the material output by the at least one chute; and
a controller configured to receive one or more signals from the at least one sensor indicative the parameter measured by the at least one sensor and adjust at least one crop processing parameter of the agricultural machine based on the one or more signals.

17. The agricultural machine of claim 16, wherein the at least one crop processing parameter of the agricultural machine that the controller is configured to adjust includes speed of the agricultural machine moving through the worksite.

18. The agricultural machine of claim 16, wherein the at least one crop processing parameter of the agricultural machine that the controller is configured to adjust includes speed of the at least one knockdown roller.

19. The agricultural machine of claim 16, wherein the at least one crop processing parameter of the agricultural machine that the controller is configured to adjust includes speed of at least one separator configured to separate billet from crop residue in the at least one chute.

20. A method of processing sugarcane with an agricultural machine in a worksite, comprising:
moving the agricultural machine at a harvesting speed through the worksite;
rotating a knockdown roller of the agricultural machine at a knockdown roller speed to convey the sugarcane through the agricultural machine;
chopping stalks of the sugarcane into billets;
rotating a fan at a fan speed to generate airflow that separates billets from crop residue;
measuring a parameter associated with material, including billets and crop residue, output from the agricultural machine; and
adjusting at least one crop processing parameter of the agricultural machine based on the measured parameter associated with the material, wherein the at least one crop processing parameter includes at least one of the harvesting speed, the knockdown roller speed, and the fan speed.
